(19) United States
(12) Patent Application Publication
(10) Pub. No.: US 2022/0395711 A1
(43) Pub. Date: Dec. 15, 2022

(54) Mask

(71) Applicant: CONTECHS MEDICAL LIMITED, Essex (GB)

(72) Inventors: Andrew MARSH, Essex (GB); Andrew DIXON, Essex (GB)

(21) Appl. No.: 17/552,781

(22) Filed: Dec. 16, 2021

(30) Foreign Application Priority Data
Jun. 15, 2021 (GB) 2108520.4

(51) Int. Cl. A62B 23/02; B29D 99/00; B29C 65/48; A41D 13/11

(52) U.S. Cl. CPC A62B 23/025; B29D 99/0071; B29C 65/48; A41D 13/11

(57) ABSTRACT

A mask for inhibiting the transmission of droplets including:
a first wall including a first portion;
a second wall including a second portion;
wherein the first and second wall are connected to each other at or near their peripheries to define a space therebetween;
an opening which extends between the first and second portions and which, in use, overlies a user's mouth;
a first connection which connects the first portion to the second portion to inhibit communication between the opening and the space;
a transparent wall which covers the opening; and
a second connection which connects the transparent wall to the first or second walls.

### FIELD

The present invention relates to the field of masks. In particular, the present invention relates to masks for use in covering a user's mouth and nose to inhibit the transmission of droplets.

### BACKGROUND

Masks which cover a user's mouth and nose are well known. In particular, they have been found to be effective at reducing the transmission of droplets to and from a user's mouth and nose. This is of particular importance for the health of the population and in particular in hospital, clinical and surgical environments.

An issue with masks is that it is not possible to view a user's mouth when they are talking. People intuitively look at a person's mouth when they are talking to understand speech and also to understand emotions that a user may be experiencing. In particular, deaf people look at people's mouths to lip read and so know what a person is saying. Therefore, masks create a barrier to communication which is clearly undesirable.

Attempts have been made to create masks through which a person is able to view a user's mouth, e.g. through the use of transparent coverings applied over an opening in the mask. However, such masks do not satisfy the strict safety criteria required for the hospital, clinical and surgical environments and so are unsuitable for use in those settings. In particular, such prior art masks suffer from a compromised performance in terms of inhibiting transmission and/or the transparent coverings are prone to becoming obscured through fog or mist forming on them during use.

The present invention at least seeks to ameliorate the above issues.

### BRIEF DESCRIPTION OF THE INVENTION

According to a first aspect of the invention we provide a mask for inhibiting the transmission of droplets including:
a first wall including a first portion;
a second wall including a second portion;
wherein the first and second wall are connected to each other at or near their peripheries to define a space therebetween;
an opening which extends between the first and second portions and which, in use, overlies a user's mouth;
a first connection which connects the first portion to the second portion to inhibit communication between the opening and the space;
a transparent wall which covers the opening; and
a second connection which connects the transparent wall to the first or second walls.

The first connection and/or second connection each may form a closed path.

The first and second portions may define respective parts of the opening.

The first connection may effect joining or fusion of the first and second portions together.

The second connection may connect the transparent wall, optionally or preferably a periphery of the transparent wall, to the first or second wall near or around the first or second portion thereof.

The second wall may include a surface which faces towards a user's face during use.

The transparent wall may be positioned on the surface.

The first connection, in front view, may overlap, overlie or be contiguous and/or congruent with the second connection.

The opening and/or the transparent wall and/or the first connection and/or the second connection may form the same shape.

The opening and/or the transparent wall and/or the first connection and/or the second connection may be concentric with each other.

The opening may be oval shaped.

The transparent wall may be oval shaped.

The first connection may be oval shaped.

The second connection may be oval shaped.

The first connection may be provided by a weld.

The first connection may be provided by an ultrasonic weld.

The second connection may be provided by an adhesive.

The adhesive may be positioned between the second wall and transparent wall or the first wall and transparent wall.

The adhesive may be positioned between the first/second portion and the transparent wall.

The adhesive may include a backing layer.

The backing layer may be formed from polyethylene (PE).

The backing layer may include first and second sides.

First and second adhesive layers may be attached to the first and second sides respectively.

The first adhesive layer may be attached to the second wall.

The second adhesive layer may be attached to the transparent wall.

The adhesive may include a synthetic rubber adhesive.

The first and/or second adhesive layer may include a synthetic rubber adhesive.

The transparent wall may include, or be formed from, polyethylene terephthalate (PET).

The mask may include a third wall connected to the first and second walls about their respective peripheries and positioned in the space between the first and second walls.

The first wall may be a sheet material, e.g. a hydrophobic material or a hydrophobic spunbond polypropylene material.

The second wall may be a sheet material, e.g. a hydrophilic material or a hydrophilic spundbond polypropylene material.

The third wall may be a sheet material, e.g. a meltblown polypropylene material.

The mask may include a third wall including a third portion that the opening extends through and/or the first connection connects the first, second and third portions.

The mask may include a positioning member for assisting in positioning a mask on a user, preferably for positioning the mask on a nose of a user.

The positioning member may be positioned at a top edge of the first and/or second wall.

The mask may include first and second attachment formations for attaching the mask to a user's face.

The first attachment formation may be a strap, or loop of material, which is attached to the first and/or second wall, preferably a first side of the first and/or second wall, which, in use, may be positioned around a user's ear.

The second attachment formation may be a strap, or loop of material, which is attached to the first and/or second wall, preferably a second side of the first and/or second wall, which, in use, may be positioned around a user's ear.

The mask may be a two-ply or three-ply mask with the first/second and/or third walls forming respective layers of the mask.

According to a second aspect of the invention we provide a method of manufacturing a face mask, including the following steps:
a) providing a mask including first and second walls including first and second portions respectively and an opening which extends between the first and second portions and a first connection which connects the first portion to the second portion;
b) providing a transparent wall;
c) positioning the transparent wall so as to cover the opening; and
d) connecting the transparent wall to the first or second walls over the opening by a second connection.

According to a third aspect of the invention we provide a method of manufacturing a face mask, including the steps of:
a) providing first and second walls including first and second portions respectively;
b) cutting an opening through the first and second portions;
c) optionally connecting the first and second portions together by a first connection;
d) providing a transparent wall;
e) positioning the transparent wall so as to cover the opening; and
f) connecting the transparent wall to the first or second walls over the opening by a second connection.

The step of providing a transparent wall may include the step of providing a transparent wall sheet.

The step of providing a transparent wall may include the step of cutting the transparent wall from the transparent wall sheet.

The step of connecting the transparent wall to the first and/or second walls over the opening by a second connection may include the second connection being formed by applying an adhesive to connect the transparent wall to the first or second wall.

Applying the adhesive to connect the transparent wall to the first and/or second wall may include providing an adhesive sheet including the adhesive and a release sheet on which the adhesive is positioned.

Applying the adhesive to connect the transparent wall to the first and/or second wall may include cutting the adhesive to match the shape of the transparent wall.

Applying the adhesive to connect the transparent wall to the first and/or second wall may include removing an inner portion of the adhesive so that a peripheral portion of the adhesive remains on the release sheet.

Applying the adhesive to connect the transparent wall to the first and/or second wall may include applying the transparent wall to the peripheral portion of the adhesive positioned on the release sheet.

The step of connecting the first and second walls may include welding the first and second portions of the walls together around the opening, or the first connection may be a weld connection between the first and second portions of the walls around the opening.

The step of providing the first and second walls may further include the step of providing first and second wall sheets.

The step of providing the first and second walls may further include the step of cutting the first and second walls from the first and second wall sheets.

The method may further include the step of providing the first and second wall sheets including providing the first and second wall sheets as a roll and unrolling the first and second wall sheets prior to cutting the first and second walls from the first and second wall sheets.

The method may further include the step of providing the transparent wall sheet includes providing the transparent wall sheet as a roll and unrolling the transparent wall sheet prior to cutting the transparent wall from the transparent wall sheet.

The method may further include the step of providing an adhesive sheet as a roll and unrolling the adhesive sheet prior to cutting the adhesive to provide the second connection.

The opening may be generally oval shaped.

The transparent wall may be generally oval shaped.

The transparent wall may be formed from polyethylene terephthalate (PET).

The adhesive may be positioned between the second and transparent walls.

The adhesive may be positioned between the second portion and the transparent wall.

The adhesive may include a backing layer.

The backing layer may be formed from polyethylene (PE).

The backing layer may include first and second sides.

First and second adhesive layers may be attached to the first and second sides respectively.

The first adhesive layer may be attached to the second wall.

The second adhesive layer may be attached to the transparent wall.

The adhesive may include a synthetic rubber adhesive.

The third aspect of the invention may include one or more or all of the features of the first and/or second aspects of the invention.

The second aspect of the invention may include one or more or all of the features of the first and/or third aspects of the invention.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a plan view of a mask, embodying the present disclosure;

FIG. 2 is a further plan view of the mask of FIG. 1;

FIG. 3 is a further plan view of the mask of FIG. 1;

FIG. 4 is an exploded view of the first, second and third walls and transparent wall of the mask of FIG. 1;

FIG. 5 is a cross-sectional view along the line 5-5 of FIG. 1;

FIG. 6 is an enlarged view of the section 6-6 of FIG. 5;

FIG. 7 is an enlarged view of the section 7-7 of FIG. 5;

FIG. 8 is a plan view of the mask of FIG. 1;

FIG. 9 is a plan view showing the rear side of the mask of FIG. 8;

FIG. 10 is a perspective view of the mask of FIG. 1 worn on a user's face;

FIG. 11 is a front view of the mask of FIG. 10 worn on a user's face; and

FIGS. 12 to 26 are schematic views of the manufacturing process for the mask of FIG. 1 and schematic views of the sub-assemblies of the mask at various stages of manufacture.

### DETAILED DESCRIPTION OF THE DISCLOSURE

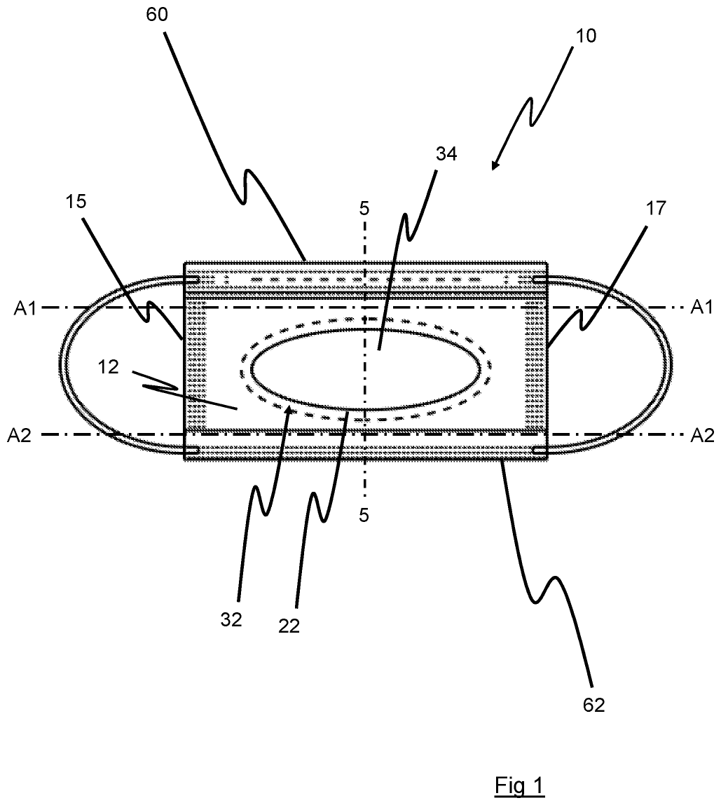

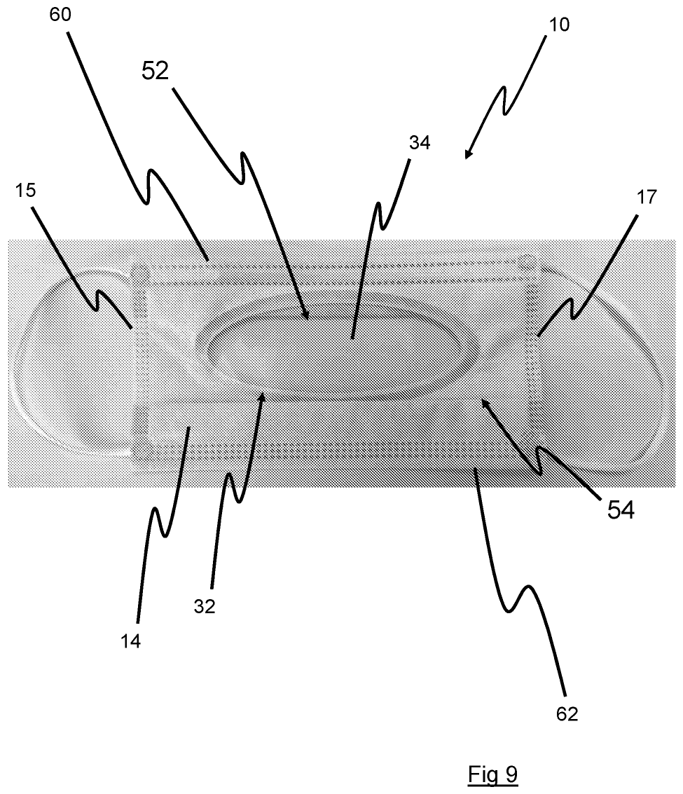

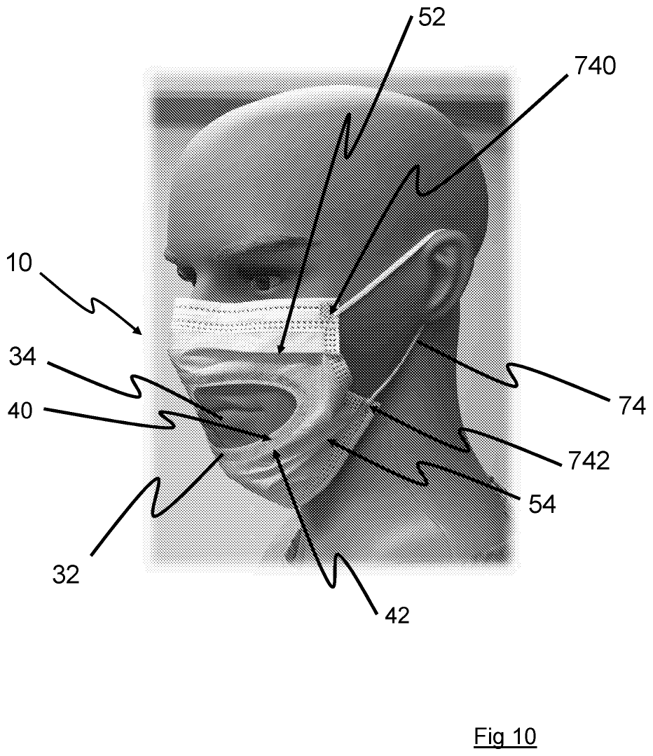

Referring to FIGS. 1 to 11 there is disclosed a mask 10 for inhibiting the transmission of droplets.

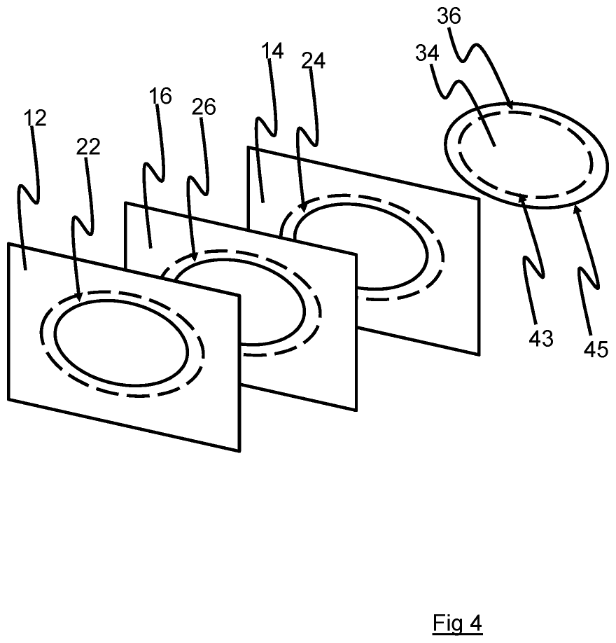

The mask includes first, second and third walls 12, 14, 16 (as can be seen in FIGS. 4, 6 and 7), commonly known as a 3-ply mask. In other embodiments more or fewer walls may be provided without departing from the scope of the present invention. For example, the mask may include first and second walls only, or may include four or more walls without departing from the scope of the present invention.

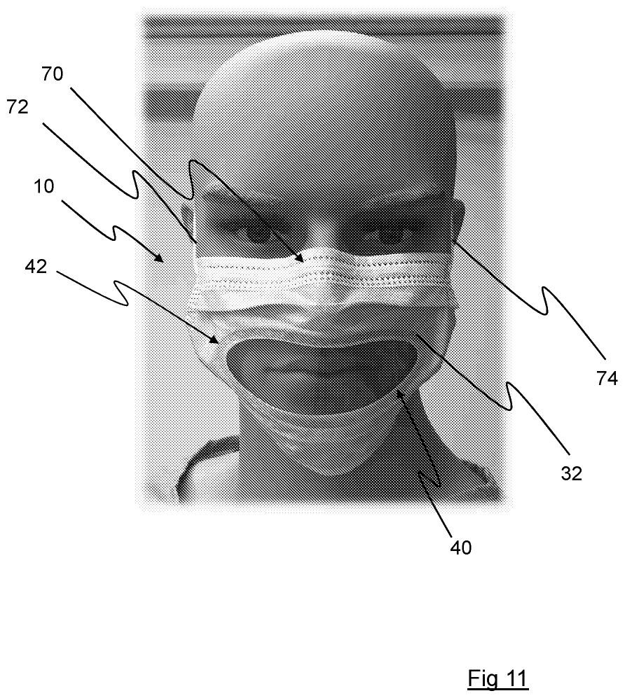

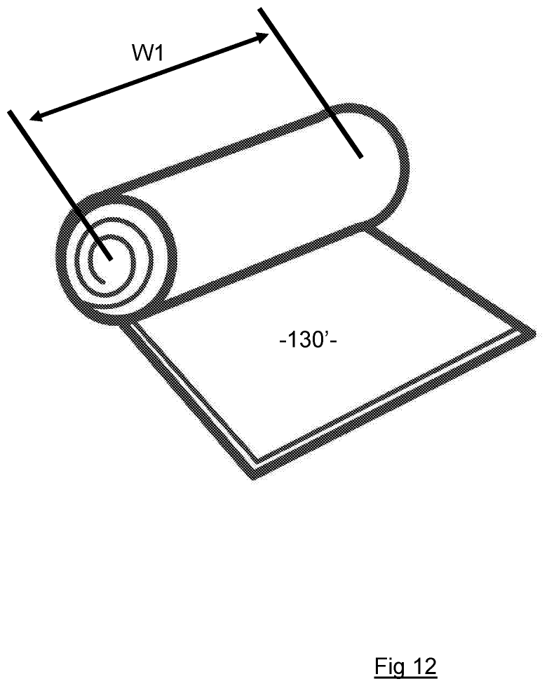

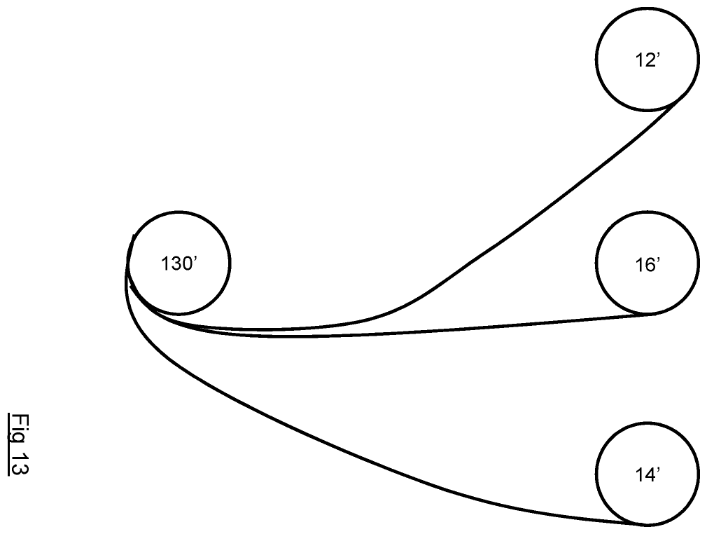

The first and second walls 12, 14 in use are positioned over a user's mouth and nose (as shown in FIGS. 10 and 11). In use, the first wall 12 faces away from a user so as to form an outer wall and the second wall 14 faces towards the user so as to form an inner wall. In particular, the first wall 12 includes a surface 1200 which faces away from a user. The second wall includes a surface 1400 which faces towards a user's face during use.

The first and second walls 12, 14 may each permit air to pass therethrough whilst inhibiting droplets, e.g. the first and/or second walls 12, 14 are gas permeable. The first and second walls 12, 14 may be made from a filter material or a material that functions as a filter.

The first wall 12 is a sheet material formed from a hydrophobic spunbond polypropylene material (SBPP). The first wall 12 is blue to indicate that it is this wall which should face outwardly in use. The second wall is a sheet material formed of a hydrophilic spunbond polypropylene material (SBPP), or spunbond polypropylene, in particular having a weight of 25 gsm. The second wall 14 is white to indicate that it is this wall which should face towards a user in use. The first and second walls 12, 14 could be formed from other materials without departing from the scope of the present invention. For example, the first and second walls 12, 14 could be formed from polyesters or other polyamides without departing from the scope of the present invention. The first wall 12 may have a hydrophobic coating applied to it, or be formed of a hydrophobic material, to inhibit the build-up of moisture on the first wall 12. Alternatively the first wall 12 may include other hydrophobic materials. The second wall 14 may have a hydrophilic coating applied to it, or be formed of a hydrophilic material, to draw moisture from the first wall 12 and/or the third wall towards the second wall 14. This may be advantageous in improving the efficiency of the mask.

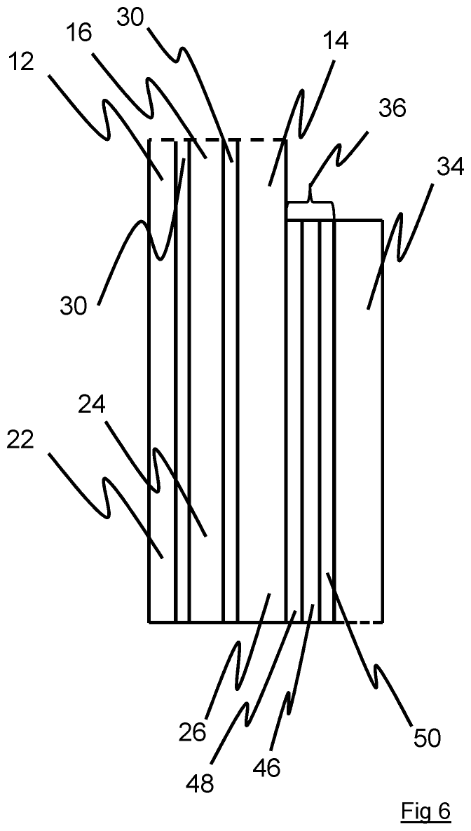

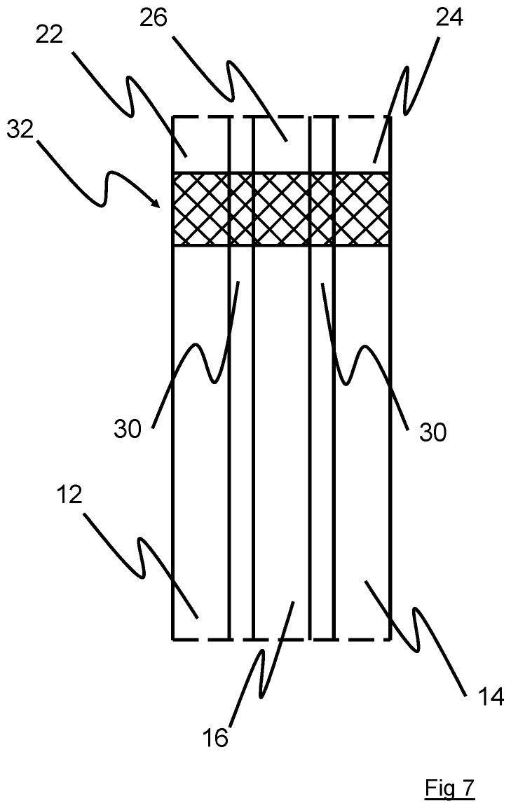

The first and second walls 12, 14 are connected to each other at or near their peripheries and define a space 30 therebetween (see FIGS. 6 and 7). In particular, the first, second and third walls 12, 14, 16 are connected about their respective peripheries, and optionally are coterminous. The third wall 16 is positioned at least partially within the space 30 between the first and second walls 12, 14. The walls 12, 14, 16 are connected about their respective peripheries but the rest of the walls, i.e. their respective inner regions, are not fixed together. This may not be the case in other arrangements.

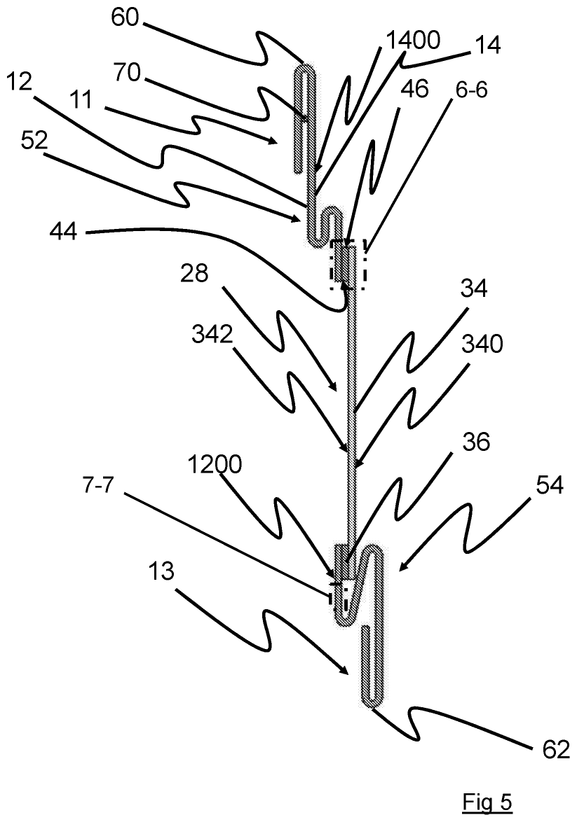

Referring to FIG. 5, the first and second walls have a respective top 11 and bottom 13. The top and bottom 11, 13 of the first and second walls 12, 14 are folded in a direction from the second wall 14 to the first wall 12 and welded to form first and second seams which define a top edge 60 and a bottom edge 62 of the mask 10. Referring to FIG. 1, the first and second walls 12, 14 have first and second respective sides 15, 17. The first and second respective sides 15, 17 are welded to seal the first and second sides 15, 17 to connect the first and second walls 12, 14 at or near their peripheries. Where a third wall 16 is provided, it is similarly folded at its respective top and bottom to define the top and bottom edges 60, 62 together with the first and second walls 12, 14. Respective sides of the third wall 16 may also be welded about their peripheries together with the sides 15, 17 of the first and second walls 12, 14

The first and second walls 12, 14 are generally rectangular in plan view. In embodiments the first and second walls 12, 14 may be other shapes without departing from the scope of the present invention. For example, the first and/or second walls 12, 14, and/or third wall 16 may be square, oval, trapezoidal or kite shaped, or any other polygonal shape. In embodiments the first and second walls 12, 14 and third wall 16 may have different shapes in plan view.

The third wall 16 is positioned, or sandwiched, between the first and second walls 12, 14 (as shown in FIGS. 6 and 7) and acts as a filter, e.g. it is gas permeable. In embodiments instead of, or in addition to, the third wall 16 the mask 10 may be provided with a filter positioned over an aperture in the first and/or second wall 12, 14. In the present embodiment the third wall 16 is generally rectangular in plan view. In particular, in the present embodiment the third wall 16 is the substantially the same size and shape as the first and/or second walls 12, 14. In other embodiments this may not be the case. In the present embodiment the third wall 16 is a sheet material. In particular, the third wall 16 is formed from a meltblown material, e.g. a meltblown polypropylene material. The material has a weight of 25 gsm. In other embodiments the third wall 16 may be formed from other filter materials as are well known in the art. For example, the third wall 16 may be formed of other non-woven forms of polypropylene, such as spunbond or spunlace polypropylene, and/or may include carbon without departing from the scope of the present invention.

The first, second and third walls 12, 14, 16 are each formed of respective materials having a weight of 25 gsm. In embodiments the first and/or second and/or third walls 12, 14, 16 may be formed of materials having a weight of at least 5 gsm, 10 gsm, 15 gsm or 20 gsm. In embodiments the first and/or second and/or third walls 12, 14, 16 may be formed of materials having a weight of at most 30 gsm, 35 gsm, 40 gsm or 45 gsm.

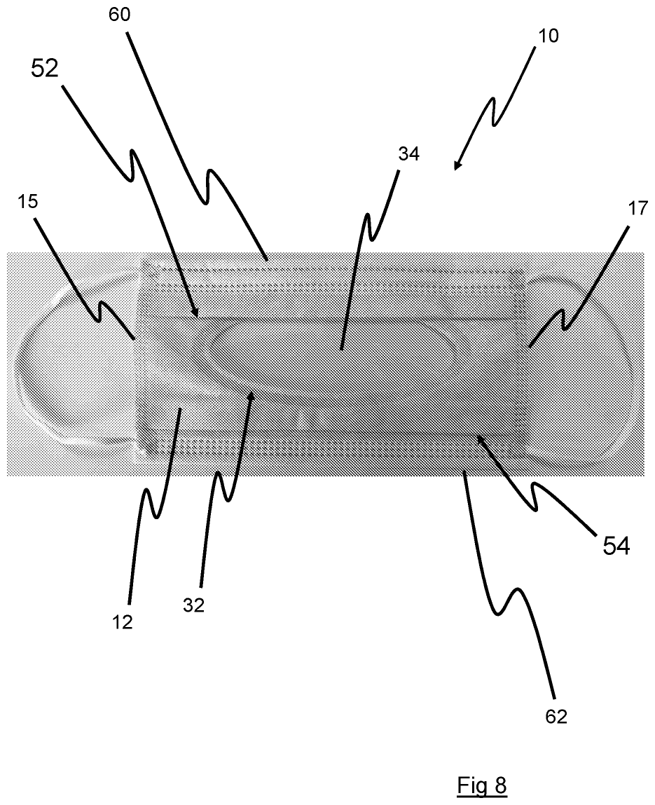

In the present embodiment the first and/or second and/or third walls 12, 14, 16 may each include a portion which extends over the opening 28 (see FIGS. 10 and 11). In embodiments this may be provided by the first and/or second and/or third walls 12, 14, 16 being pleated, as described below, or otherwise folded or positioned in front of the opening 28. During use the portion of the first and/or second and/or third walls 12, 14, 16 which extends over the opening 28 may move such that they no longer overlie the opening 28 as the mask is stretched over a user's face (for example see FIGS. 8 to 11).

The first, second and third walls 12, 14, 16 are folded about first and second generally horizontal axes A1, A2 (in plan view with the mask orientated horizontally) to form first and second pleats 52, 54 in the mask 10 (see FIGS. 1 and 4). In embodiments one or both of the axes A1, A2 may not be generally horizontal and may be, for example, inclined at an angle with respect to the upper edge 60 and/or the bottom edge 62 of the mask 10. The pleats 52, 54 are advantageous in enabling a secure fitment of the mask 10 to the user and ensuring the user is able to speak whilst wearing the mask.

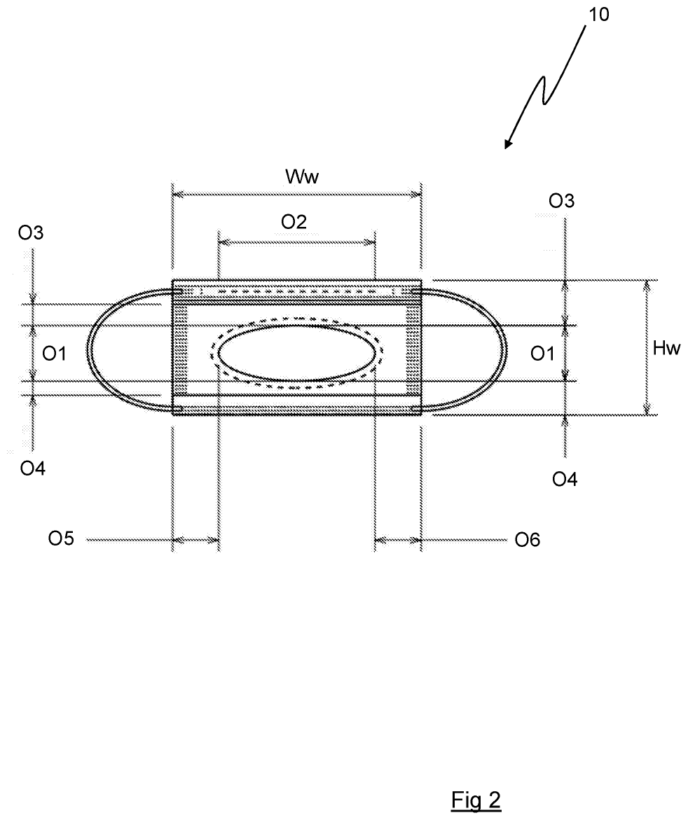

Referring to FIG. 2, when assembled the first, second and third walls 12, 14, 16 have a height Hw and width Ww. In the present embodiment the height Hw is 95 mm and the width Ww is 175 mm. In embodiments the first, second and third walls 12, 14, 16 may have a height Hw of at least 60 mm; 70 mm; 80 mm; or 90 mm. In embodiments the first, second and third walls 12, 14, 16 may have a height Hw of at most 100 mm; 110 mm; 120 mm; or 130 mm. In embodiments the first, second and third walls 12, 14, 16 may have a width Ww of at least 60 mm; 150 mm; 160 mm; or 170 mm. In embodiments the first, second and third walls 12, 14, 16 may have a width Ww of at most 180 mm; 190 mm; 200 mm; or 210 mm.

The axis A1 about which the first pleat 52 is folded is positioned approximately 32 mm from the top edge 60 in a direction generally orthogonal to the axis A1. In embodiments the first pleat 52 may be positioned at least 5 mm, 15 mm, 25 mm or 30 mm from the top edge 60 in a direction generally orthogonal to the axis A1. In embodiments the first pleat 52 may be positioned at most 35 mm, 40 mm, 45 mm or 50 mm from the top edge 60 in a direction generally orthogonal to the axis A1.

The axis A2 about which the second pleat 54 is folded is positioned approximately 24 mm from the bottom edge 62 in a direction generally orthogonal to the axis A2. In embodiments the second pleat 54 may be positioned at least 5 mm, 10 mm, 15 mm or 20 mm from the bottom edge 62 in a direction generally orthogonal to the axis A2. In embodiments the second pleat 54 may be positioned at most 25 mm, 30 mm, 35 mm or 40 mm from the bottom edge 62 in a direction generally orthogonal to the axis A2.

In the present embodiment the first and second pleats 52, 54 differ in the degree to which they are folded over and the direction of the folds. For example, the first pleat 52 is folded so that it lies in front or to the front side of a transparent wall 34 (see FIG. 5), described in more detail below, whereas the second pleat 54 is folded so that it lies behind the transparent wall 34 or to the rear side of transparent wall 34. In embodiments the first and second pleats 52, 54 may lie to the same side of the transparent wall 34. Each of the first and second pleats 52, 54 are formed by two folds that form an S-shape

Referring to FIGS. 4, 6 and 7 the first, second and third walls 12, 14, 16 include respective first, second and third portions 22, 24, 26. An opening 28 extends between the first, second and third portions 22, 24, 26. The first portion 22 and the second portion 24, or the first portion 22, second portion 24 and the third portion 26, define respective parts of the opening 28. The portions 22, 24 and/or 26 are regions of the walls 12, 14, 16 which are proximate to the opening 28, or extend near or around the opening. The opening 28 is generally oval shaped. The first, second and third portions 22, 24, 26 are positioned generally centrally in the first, second and third walls 12, 14, 16 in the present embodiment. In embodiments the first, second and third portions 22, 24, 26 may be positioned closer to the top or bottom edge 60, 62 of the first, second and third walls 12, 14, 16 and/or the first or second sides 15, 17 without departing from the scope of the present invention. In the present embodiment the first, second and third portions 22, 24, 26 are a similar shape to the opening 28, and in particular are generally oval shaped. In embodiments the first, second and third portions 22, 24, 26 may be other shapes such as square, rectangular, circular, stadium shaped or any other polygonal shape without departing from the scope of the present invention. In embodiments the opening 28 may extend between the first and second portions 22, 24. In embodiments the opening 28 may be square, rectangular, circular, stadium shaped or any other polygonal shape without departing from the scope of the present invention.

The opening 28, in use, overlies a user's mouth.

Referring to FIG. 2, the opening 28 has a maximum height Oland a maximum width O2. The width direction being parallel to the axes A1, A2, A3. In the present embodiment the O1 is 39 mm and O2 is 110 mm. In embodiments O1 may be at least 25 mm; 30 mm; 32 mm; or 35 mm. In embodiments O1 be at most 40 mm; 42 mm; 45 mm; or 50 mm. In embodiments the O2 be at least 90 mm; 95 mm; 100 mm; or 105 mm. In embodiments O2 be at most 115 mm; 120 mm; 125 mm; or 130 mm.

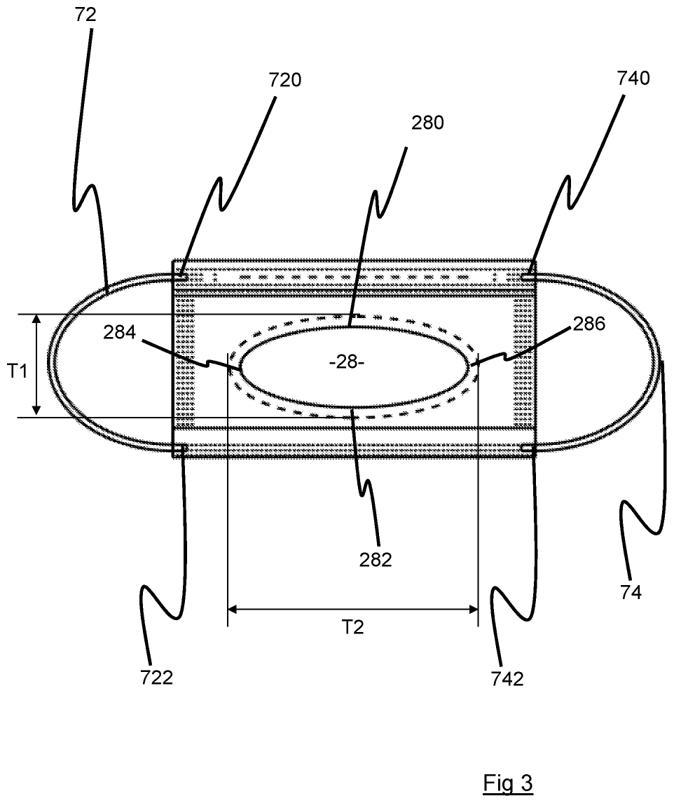

Referring to FIG. 3, in the present embodiment the opening 28 is positioned generally centrally in the first and second walls 12, 14. In particular, the opening 28 has a top 280 and a bottom 282 and first and second sides 284, 286 (see FIGS. 2 and 3). The top 280 is positioned a distance O3 from the top edge 60 of 32 mm. The bottom 282 is positioned a distance O4 from the bottom edge 62 of 24 mm. The first side 284 is positioned a distance O5 from the first side 15 of 32.5 mm. The second side 286 is positioned a distance O6 from the second side 17 of 32.5 mm. In embodiments the top 280, bottom 282, first side 284 and second side 286 may be positioned at least 5 mm, 10 mm, 15 mm, or 20 mm from a respective edge or side of the first and/or second walls 12, 14. In embodiments the top 280, bottom 282, first side 284 and second side 286 may be positioned at most 25 mm, 30 mm, 35 mm, or 40 mm from a respective edge or side of the first and/or second walls 12, 14.

The mask 10 includes a positioning member 70 (see FIG. 5) for assisting in positioning a mask on a user and in particular for positioning the mask on a nose of a user. The positioning member, or nose band, 70 is positioned at the top edge 60 of the mask in a generally central position of the mask 10 and extends lengthwise of the mask 10. In particular the nose band 70 is positioned adjacent the top 11 of the first and second walls 12, 14 in the fold of the first and second walls 12, 14 which forms the top edge 60 of the mask 10. In other words the nose band 70 is enveloped by an outwardly facing surface of the first wall 12. The nose band 70 is then welded into position as part of the welding process which defines the top and bottom edges 60, 62. In embodiments the nose band 70 may be positioned on an outwardly facing surface of the first and/or second wall 12, 14 or may be positioned in between the first and/or second and/or third walls 12, 14, 16 without departing from the scope of the present invention.

A centre of the nose band 70 lies above the centre of the opening 28.

The nose band 70 in the present embodiment is resiliently deformable and may be moulded to a user's face. In embodiments the nose band 70 may be relatively rigid. In embodiments the nose band 70 may be relatively soft to provide added comfort to a user and to improve sealing of the mask 10 to a user's face (as demonstrated in FIGS. 10 and 11 where the nose band 70 is following the contour of the nose on the face). In the present embodiment the nose band 70 is a metal wire, or first and second substantially parallel metal wires, which a user may deform when applying the mask to their face. The wire may be a single core wire or may be a double core wire. The wire may be formed of aluminium or any other suitable metal as is known in the art. In embodiments the wire may be formed from mouldable plastics.

The wire in the present embodiment has a generally circular cross-section. In other embodiments the wire may have a generally flat cross-section, a triangular cross-section or other polygonal cross-section without departing from the scope of the present invention. The nose band 70 has a length of 110 mm and a diameter of 3.0 mm. In embodiments the nose band 70 may have a length of at least 90 mm, 95 mm, 100 mm, or 105 mm. In embodiments the nose band 70 may have a length of at most 115 mm, 120 mm, 125 mm, or 130 mm.

The mask 10 includes first and second attachment formations 72, 74 for attaching the mask 10 to a user's face (see FIGS. 3, 10 and 11 in particular). In the present embodiment the first and second attachment formations 72, 74 are provided as straps which are attached to the first and second sides 15, 17 of the first and second walls 12, 14 and which, in use, are positioned around a user's ears. In particular the first and second attachment formations 72, 74 have respective first and second ends 720, 722, 740, 742. In the present embodiment the respective first ends 720, 740 are positioned towards the top edge 60 of the mask 10 and the second ends 722, 742 are positioned towards the bottom edge 62 of the mask 10.

In embodiments only a single attachment formation may be provided. For example, a single attachment formation may be provided which is attached to the first and second sides 15, 17 of the first and second walls 12, 14 and which in use passes around the back of a user's head. Two or more such attachment formations could be provided at or near the top and bottom edges 60, 62 of the mask 10 to improve fitment of the mask 10 to a user.

The straps 72, 74 are formed from an elastic material to permit secure fitment of the mask 10 to a user. In particular, the straps 72, 74 include nylon and spandex. The straps 72, 74 in particular include latex free elastic or elastic not made with natural rubber latex. In embodiments other materials could be used to form the straps 72, 74 without departing from the scope of the present invention. For example, the straps 72, 74 could be formed from the same material as the first and/or second and/or third walls 12, 14, 16. Such straps 72, 74 could be formed as extensions of the first and/or second and/or third walls 12, 14, 16. The straps 72, 74 in cross-section are relatively flat to enhance user comfort. In embodiments the straps 72, 74 may have a generally circular cross-section, a triangular cross-section or other polygonal cross-section without departing from the scope of the present invention.

The straps 72, 74 are welded onto the first or second wall 12, 14 in the present embodiment. In embodiments the straps 72, 74 may be connected to the mask 10 by adhesive or may be stitched in or may be connected by any other means as is well known in the art. In embodiments the straps 72, 74 may be connected to the first wall 12 and/or the second wall 14 and/or the third wall 16 without departing from the scope of the present invention.

The straps 72, 74 each have a length of 180 mm. In embodiments the straps 72, 74 may have a length of at least 140 mm, 150 mm, 160 mm, or 170 mm. In embodiments the straps 72, 74 may have a length of at most 190 mm, 200 mm, 210 mm, or 220 mm.

In the present embodiment the first and second attachment formations 72, 74 are substantially the same. In embodiments the first and second attachment formations 72, 74 may differ.

Referring to FIGS. 4,7 to 11, a first connection 32 connects the first portion 22 to the second portion 24, or the first portion 22, second portion 24 and third portion 26, to inhibit communication between the opening 28 and the space 30. The first connection 32 effects joining or fusion of the first and second portions 22, 24 together. In the present embodiment the first connection 32 forms a closed path around the opening 28. In particular the first connection 32 is oval shaped.

In the present embodiment the first connection 32 is provided by an ultrasonic weld, preferably at 20 kHz, between the first and second portions 22, 24. In other embodiments other connection means could be used without departing from the scope of the present invention. Other types of weld could be used, for example heat welding, radiofrequency, or electron beam welding without departing from the scope of the present invention. Further, the first connection could be provided by other connection means such as an adhesive connection or bonding using a tie-layer could be used without departing from the scope of the present invention.

The mask 10 includes a transparent wall 34, as shown in FIGS. 1 to 11, and as mentioned above. The transparent wall 34 covers the opening 28. In particular, the transparent wall 34 is attached over the opening 28 as described in more detail below. In particular a periphery of the transparent wall 34 overlies the second portion 24 of the second wall 14. The transparent wall 34 in the present embodiment overlies the second portion 24 of the second wall 14 by 5 mm. In embodiments the transparent wall 34 may overlie the second portion 24 of the second wall 14 by at least 2 mm, 3 mm or 4 mm. In embodiments the transparent wall 34 may overlie the second portion 24 of the second wall 14 by at most 6 mm, 7 mm or 8 mm. By transparent, we mean that the wall 34 permits an observer to clearly see a user's mouth such that an observer can tell what movements the user's mouth is making. This is advantageous for permitting an observer who can lip read be able to understand what a user is saying to them. In the present example the transparent wall 34 is see-through, i.e. no colour or pigments are present in the wall 34. However, in other embodiments the wall 34 may include a colour or pigment.

In the present embodiment the transparent wall 34 is a similar shape to the opening 28, and in particular is oval shaped. In embodiments the transparent wall 34 may be square, rectangular, circular, stadium shaped or any other polygonal shape without departing from the scope of the present invention.

Referring to FIG. 3, the transparent wall 34 has a maximum height T1 and a maximum width T2. In the present embodiment T1 is 49 mm and T2 is 120 mm. In embodiments T1 is at least 35 mm; 40 mm; 42 mm; or 45 mm. In embodiments T1 may be at most 50 mm; 52 mm; 55 mm; or 60 mm. In embodiments T2 may be at least 100 mm; 105 mm; 110 mm; or 115 mm. In embodiments T2 may be at most 125 mm; 130 mm; 135 mm; or 140 mm.

The transparent wall 34 has a thickness of 0.1 mm. In embodiments the transparent wall 34 may have a thickness of at least 0.05 mm; 0.06 mm; 0.07 mm; 0.08 mm; or 0.09 mm. In embodiments the transparent wall 34 may have a length of at most 0.11 mm; 0.12 mm; 0.13 mm; 0.14 mm or 0.15 mm.

The transparent wall 34 in the present embodiment is substantially gas and liquid impermeable. In particular, the transparent wall 34 includes, or is formed from, polyethylene terephthalate (PET). The transparent wall 34 includes first and second respective surfaces 340, 342 on which a hydrophilic coating is applied. This is advantageous in reducing fogging of the transparent wall 34 in use. In embodiments the transparent wall 34 may include, or be formed from, polyester laminates, multilayer films including ethylene vinyl acetate (EVA), polyvinylidene chloride (PVDC), polyester, polyamides, or polyurethanes. Examples of suitable materials for the transparent wall 34 are 3M 9960 and 3M 9962. In embodiments, the transparent wall 34 may be made from a hydrophilic material and/or have a hydrophilic coating applied thereto. The transparent wall 34 may also be made from or be coated to be a microfluidic material.

As mentioned above, a second connection 36 connects the transparent wall 34, optionally or preferably a periphery of the transparent wall 34, to the second wall 14, preferably near or around the second portion 24 thereof. The second connection 36 connects the outwardly facing surface 342, i.e. facing away from the user, of the transparent wall 34 to the inwardly facing surface 1400, i.e. facing towards the user, of the second wall 14. The transparent wall 34 is closest to the user's face in comparison to the first, second and third walls 12, 14, 16. In other words the transparent wall 34 is positioned on the surface 1400 of the second wall 14. In particular, the second connection 36 is between the second portion 24 and the transparent wall 34. In embodiments the second connection 36 may connect the transparent wall 34, optionally or preferably a periphery of the transparent wall 34, to the first wall 12, preferably near or around the first portion 22 thereof.

The second connection 36 forms a closed path around the opening 28. In particular, the second connection 36 is positioned at, and follows, a periphery 38 of the transparent wall 34. This enables a secure connection of the transparent wall 34 to the second wall 14 whilst permitting a clear view of a user's mouth in use. In the present embodiment the second connection 36 is oval-shaped. The second connection 36 forms a barrier between the region that the transparent wall 34 overlies the second wall 14 (or overlies first wall 12 for embodiments where the transparent wall 34 connects thereto) so as to effectively seal this region with respect to the opening 28.

In the present embodiment the second connection 36 is formed by an adhesive. Referring to FIG. 6, in the present embodiment the adhesive is a double sided adhesive tape and, in particular, includes a backing layer 46, preferably formed of polyethylene (PE), having first and second respective sides. In embodiments the backing layer 46 may alternatively be formed of polyester. First and second adhesive layers 48, 50 are attached to the first and second respective sides. The first adhesive layer 48 is attached to the second portion 24 of the second wall 14 and the second adhesive layer 50 is attached to the periphery 38 of the transparent wall 34. The first and/or the second adhesive layer 48, 50 in the present embodiment are a synthetic rubber adhesive. In other embodiments other adhesives may be used without departing from the present invention. For example, a hot melt adhesive or a cured adhesive may be used without departing from the present invention. In embodiments the first and/or second adhesive layer 48, 50 may be, or include, synthetic rubber, acrylate, EVA, PVA, PVC or epoxies. In embodiments the adhesive may include only an adhesive layer 48. Non-limiting examples of suitable adhesives, or adhesive tapes, for the present invention are as follows: 3M 1510; 3M 1567; 3M 1504XL; 3M 9969.

The first connection 32 may be provided so that it does not extend all the way to the opening 28. In other words, there are regions of the first, second and/or third portions 22, 24, 26 that are not connected together and extend past the first connection 32 to the opening 28. As best seen in FIG. 5, in embodiments, the second connection 36 may be provided so that it extends to, or close to, the edge of the opening 28, in other words the second connection 36 may be contiguous and/or congruent with the opening 28.

With reference to FIG. 10, the first and second connections 32, 36 may overlap each other. In particular, in the present embodiment, in plan view, the first connection 32 has inner and outer peripheries 40, 42 and the second connection 36 has inner and outer peripheries 43, 45. The outer periphery 42 of the first connection 32 is positioned closer to the opening 28 than the outer periphery 45 of the second connection 36 and the inner periphery 40 of the first connection 32 is positioned further from the opening 28 than the inner periphery 43 of the second connection 36. In embodiments this may not be the case. For example, the outer periphery 40 of the first connection 32 may be positioned further from the opening 28 than the outer periphery 45 of the second connection 36. The inner periphery 40 of the first connection 32 may be positioned closer to the opening 28 than the inner periphery 43 of the second connection 36. Alternatively, in embodiments, the first and second connections 32, 36 in plan view may substantially overlie or be contiguous and/or congruent with each other.

In the present embodiment the first and second connections 32, 36 are substantially the same shape. However, in other envisaged embodiments the first and second connections 32, 36 may have different shapes. In embodiments the first and/or second connections 32, 36 may be square, rectangular, circular, stadium shaped or any other polygonal shape without departing from the scope of the present invention.

In the present embodiment the opening 28 and the transparent wall 34 and the first connection 32 and the second connection 36 form the same shape. In embodiments the opening 28 and/or the transparent wall 34 and/or the first connection 32 and/or the second connection 36 form the same shape. Preferably the opening 28 and/or the transparent wall 34 and/or the first connection 32 and/or the second connection 36 are concentric with each other and optionally or preferably are oval shaped.

Referring to FIGS. 12 to 26 there is also provided a method of manufacturing a mask according to the present invention. A brief outline of the steps to manufacture the mask is provided in Table 1 below. The manufacturing process described below can be used to form a plurality of masks. However, for the sake of simplicity the process is described below in relation to a single mask. It will be readily appreciated that where a single feature of a mask has been described, e.g. an opening being formed, this process can be repeated multiple times to form multiple masks as will be understood by someone skilled in the art.

TABLE 1
steps to manufacture a mask

| Step | Process step | Sub Assembly |
|---|---|---|
| 1a | Cut 3 ply material or first, second and third wall sheets to roll width | |
| 1b | Combine first, second and third wall sheets into a 3 ply material | |
| 1c | Feed 3 ply material | |
| 1d | Feed in positioning member | |
| 1e | Cut positioning member to size and position on the first and second | |
| | walls sheets | |
| 1f | Fold top and bottom of the first and second walls and weld into | |
| | position | |
| 1g | Cut the opening into the first, second and third portions | |
| 1h | Connect the first, second and third portions | First sub-assembly |
| | | complete |
| 2a | Cut transparent wall material to roll width | |
| 2b | Feed in transparent wall sheet | |
| 2c | Remove excess adhesive from release sheet | |
| 2d | Cut transparent wall from transparent wall material | |
| 2e | Apply transparent wall to adhesive | Second sub- |
| | | assembly complete |
| 3a | Feed transparent wall assembly | |
| 3b | Feed mask body roll | |
| 3c | Apply transparent wall assembly to the mask body roll over the | |
| | opening | |
| 3d | Press transparent wall onto the second portion | |
| 3e | Fold first and second wall sheets to form pleats | |
| 3f | Cut the first and second walls from the first and second wall sheets | |
| 3g | Connect first and second walls at the first and second sides | |
| 3h | Feed in attachment formations to first and second sides | |
| 3i | Connect attachment formations to the first and/or second walls | Mask complete |

At step 1a (see FIG. 12) a 3 ply sheet 130′ is cut to a correct width W1 ready to be used to form the mask. In embodiments the 3 ply sheet may be supplied at the correct width to be used, and therefore need not be cut to width. In embodiments first, second and third wall sheets 12′, 14′, 16′ may be provided which are formed of material from which the first, second and third walls 12, 14, 16 are to be constructed. Each of the first, second and third wall sheet 12′, 14′, 16′ may be cut to a correct width W1 ready to be used to form the mask.

Referring to step 1b and FIG. 13 the first, second and third wall sheets 12′, 14′, 16′ are provided which are formed of material from which the first, second and third walls 12, 14, 16 are to be constructed. Accordingly, the first and second walls are provided. The first and second walls are substantially as described above in relation to the mask 10 and include first and second portions 22, 24 respectively. The first, second and third wall sheets are layered so that the third wall sheet is positioned between the first and second wall sheets and the second wall sheet is positioned at the bottom. In other words, the first, second and third wall sheets are combined to form a 3 ply sheet 130′. In embodiments the first, second and third walls sheets 12′, 14′, 16′ are provided as separate rolls which are unrolled and layered into a 3 ply sheet 130′. Once layered the first, second and third wall sheets are rolled up ready to be used subsequently. In embodiments the first, second and third wall sheets may be supplied as a 3 ply sheet. In embodiments the first, second and third wall sheets may not be rolled up into a roll.

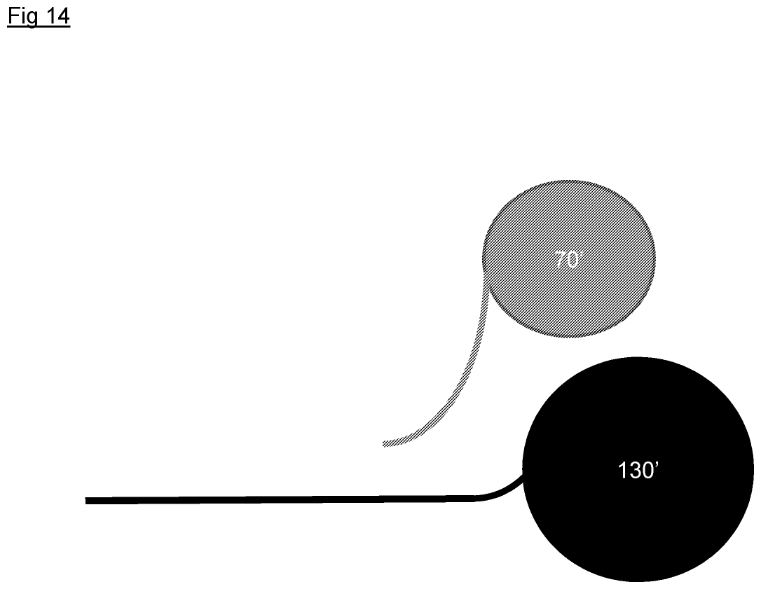

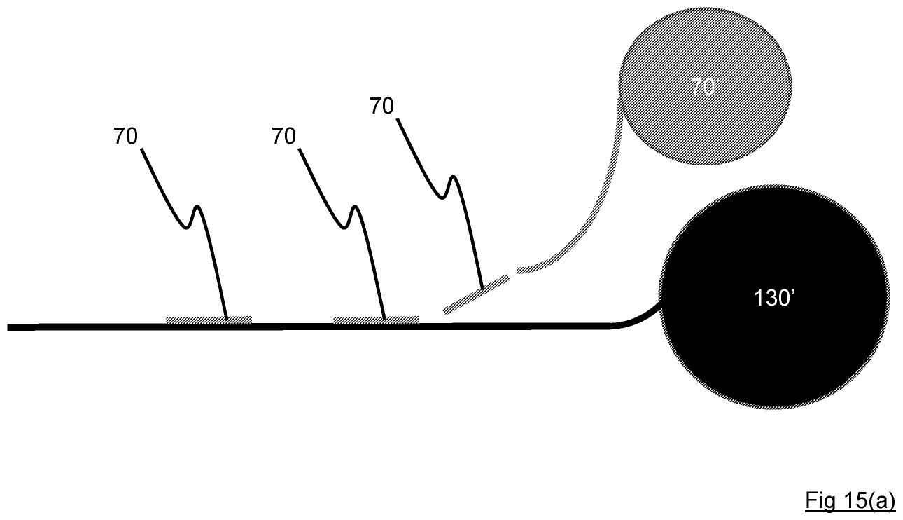

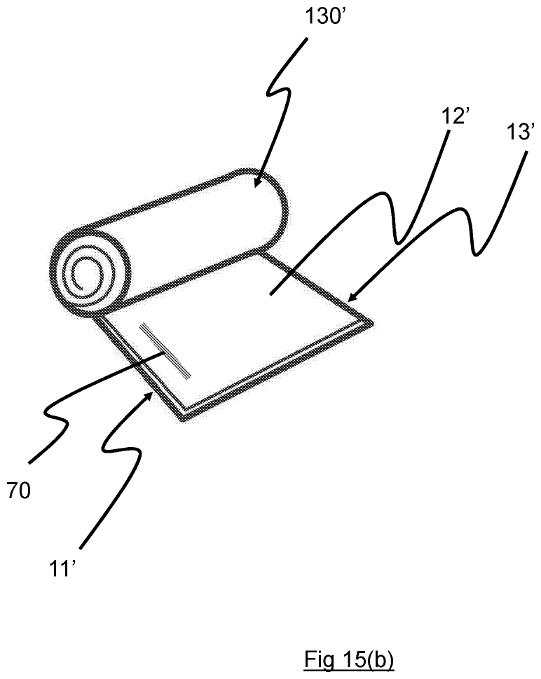

Referring to FIG. 14 and steps 1c and 1d the 3 ply sheet 130′ is unrolled and fed into the manufacturing line. A reel of positioning member material 70′ is also fed into the manufacturing line.

Referring to FIGS. 15(a) and (b) and step 1e the positioning member 70 is cut from the reel of positioning member material 70′ and is positioned on the 3 ply sheet 130′ ready to be fixed in position. In other words the positioning member 70 is positioned on the first and/or second wall sheets 12′, 14′. In embodiments the positioning member 70 may be supplied ready formed to the 3 ply sheet 130′, or first and second wall sheets 12′, 14′.

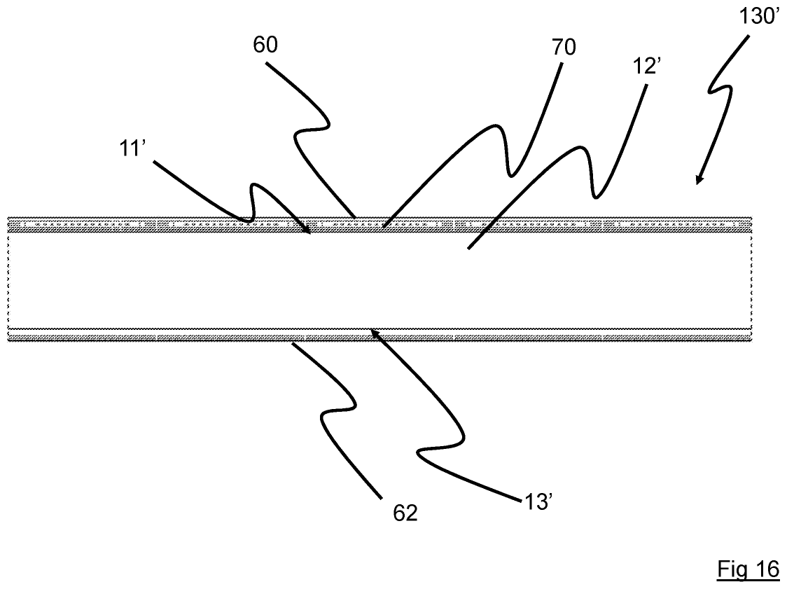

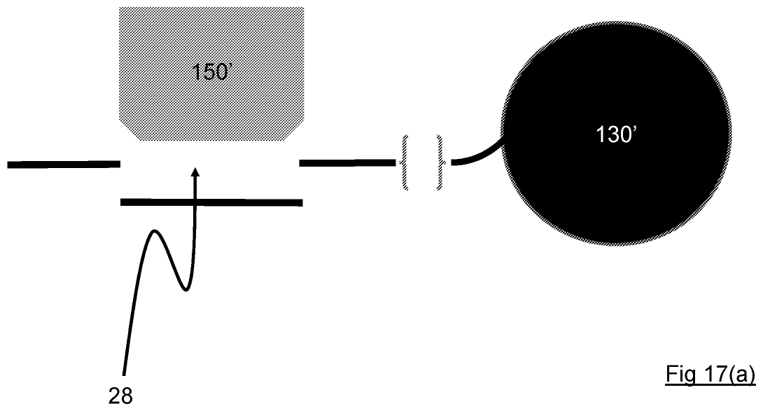

As explained in relation to the mask 10 the first, second and third walls 12, 14, 16 have a top 11 and a bottom 13, and the mask 10 has a top edge 60 and a bottom edge 62. Accordingly, the 3 ply sheet also has a top 11′ and a bottom 13′. Referring to FIGS. 16(a) and (b), at step if the top 11′ and bottom 13′ of the 3 ply sheet are folded on top of the first wall layer and are connected thereto to form the top edge and bottom edge 60, 62. In other embodiments the top 11′ and/or bottom 13′ of the 3 ply sheet 130′ may be folded on top of the second wall layer and connected thereto. In particular the top 11′ and bottom 13′ are welded to the first wall layer. In embodiments the top 11′ and bottom 13′ may be connected using other means. For example the top 11′ and bottom 13′ may be adhered to the first and/or second wall layers, or may be stitched to the first and/or second wall layers without departing from the scope of the present invention.

As the top 11′ is folded into position the positioning member 70 is fixed in position on the 3 ply sheet 130′. In particular the positioning member 70 is positioned underneath the top 11′ once it is folded over onto the first wall layer so as to be positioned at the top edge 60. In other embodiments the positioning member 70 may be positioned below the top 11′ once folded into position without departing from the scope of the present invention. Alternatively the positioning member 70 may be positioned on an outwardly facing surface of the top 11′ once it is folded into position.

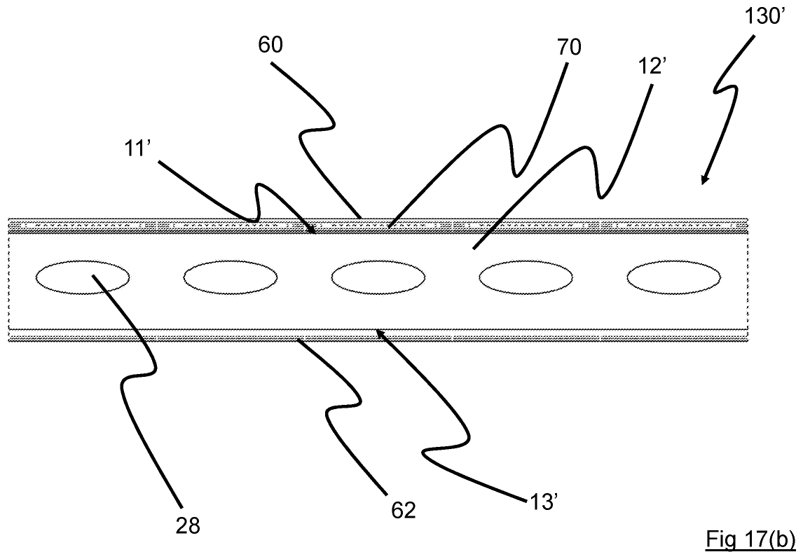

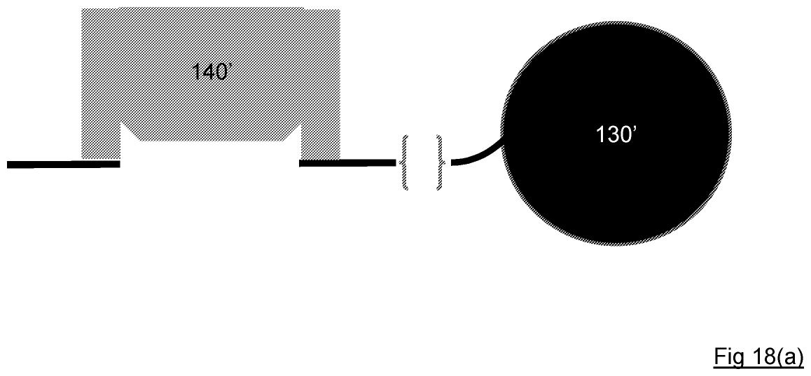

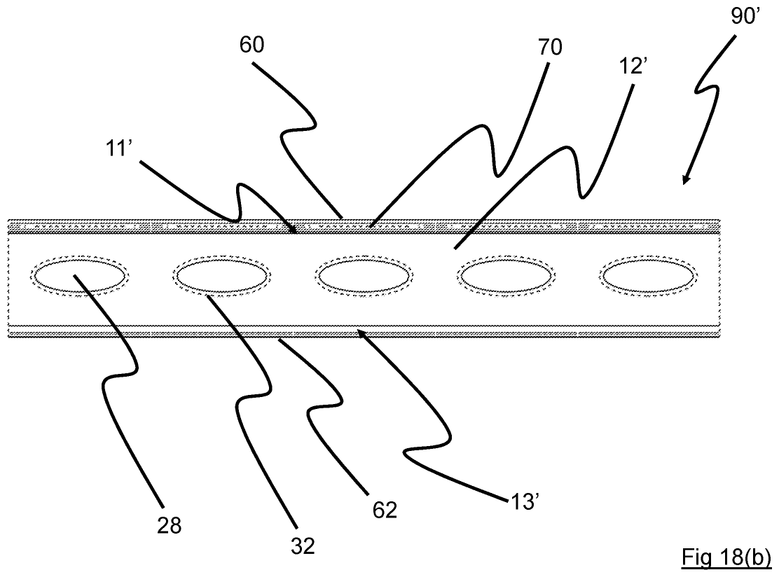

At step 1g (see FIGS. 17(a) and 15(b)) an opening 28 is cut through the first, second and third wall sheets 12′, 14′, 16′. In particular, an opening 28 is cut through the first, second and third portions 22, 24, 26 using a hole punch 150′. This is to permit viewing of a user's mouth through the transparent wall 34 once it has been connected or attached to the first and/or second wall sheets 12′, 14′. In the present embodiment the opening 28 is oval shaped. In embodiments the opening 28 may include one or more or all of the features described above in relation to the opening 28.

At step 1h (see FIGS. 18(a) and 16(b)), the first, second and third portions 22, 24, 26 of the first, second and third wall layers are connected to create the first connection 32. In the present embodiment the first, second, and third portions 22, 24, 26 are welded together using a heat sealer 140′. In other words, the first connection 32 is a weld connection between the first, second, third portions 22, 24, 26 which would extend around the opening 28 when it is formed later in the process. The weld forms a closed path and may be substantially annular or oval shaped. In particular the connection between the first, second, and third portions 22, 24, 26 may include one or more or all of the features described above in relation to the first connection 32 of mask 10. In embodiments where a third wall 16 is not provided, it will be understood that the opening 28 is cut into the first and second walls 12, 14 and similarly the first and second portions 22, 24 are connected together to form the first connection 32.

After step 1h a first sub-assembly sheet 90′ for manufacturing a mask is formed. The first sub-assembly sheet 90′ may then be rolled up ready for a subsequent manufacturing step.

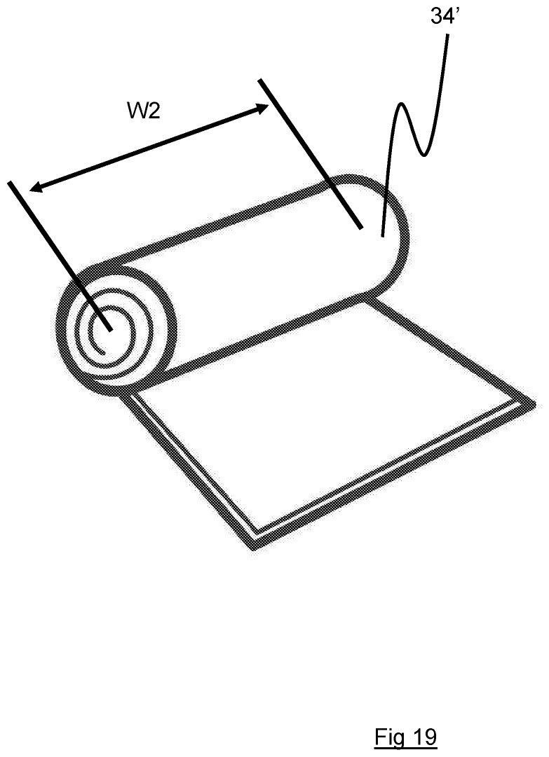

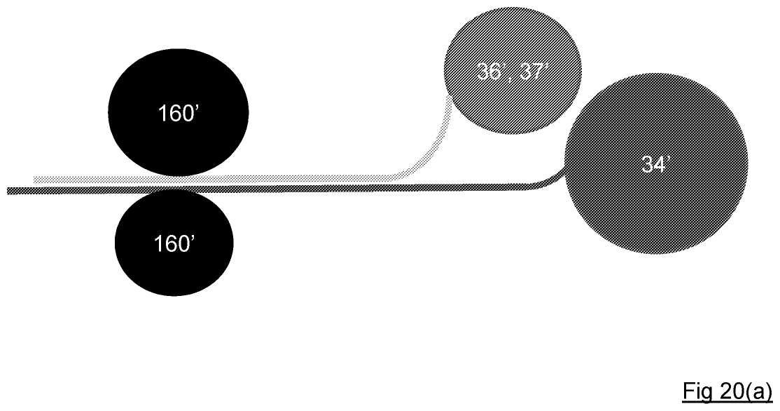

At step 2a (see FIG. 19) a transparent wall 34 is provided as part of a transparent wall sheet 34′. The transparent wall sheet 34′ may be provided as a roll. The transparent wall sheet 34′ is then cut to the appropriate width W2 for steps 2b to 2e. In embodiments the transparent wall sheet 34′ may be provided at the appropriate width without departing from the scope of the present invention.

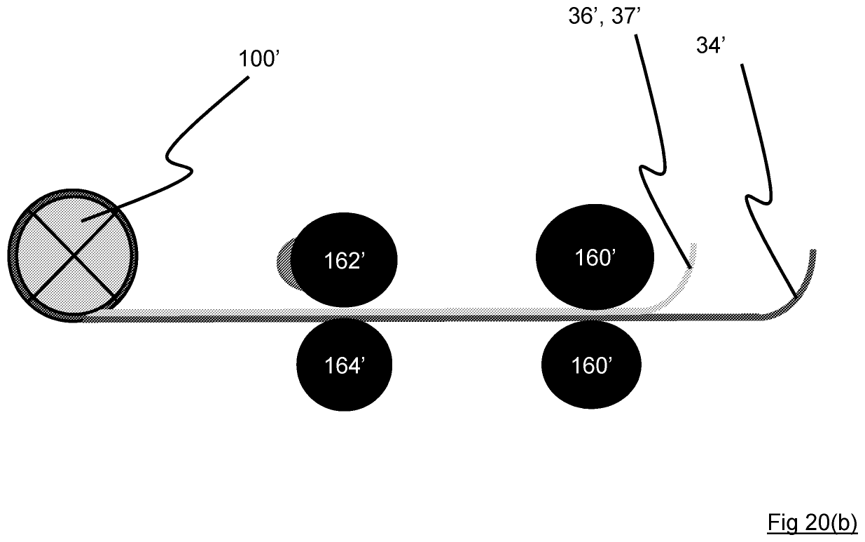

At steps 2b and 2c (FIGS. 20(a) to (c)) the transparent wall sheet 34′ is unrolled and fed into the manufacturing process. Simultaneously an adhesive sheet 36′ provided on a release sheet 37′ is fed into the manufacturing process. The adhesive sheet 36′ and/or the release sheet 37′ may be provided as a roll. A pair of rollers 160′ bring the transparent wall sheet 34′ and the adhesive sheet 36′ adjacent each other. A first adhesive shape is cut into the adhesive sheet 36′ by a profile roller 162′ which is supported by a further roller 164′. The first adhesive shape is substantially the same shape as a periphery of the transparent wall 34 as provided on mask 10. In other words the adhesive is cut to form a shape that matches the transparent wall 34. In the present embodiment the first adhesive shape is oval shaped in plan view. An inner portion of adhesive sheet 36′ is removed so a peripheral portion 92′ of the adhesive remains on the release sheet 37′ which will attach to a periphery of the transparent wall 34 on the transparent wall sheet 34′. The peripheral portion 92′ corresponds to the second connection 36 shown in FIG. 4. In the present embodiment this is achieved by kiss-cutting the adhesive sheet 36′ and the release sheet 37′ so as to cut through the adhesive sheet 36′ but leave the release sheet 37′ intact. This is advantageous as is enables the adhesive to be stored again once prepared. Other methods of cutting the adhesive could be used without departing from the scope of the present invention.

At step 2d the transparent wall 34 is cut from the transparent wall sheet 34′. In the present embodiment this is achieved by die cutting the transparent wall 34 from the transparent wall sheet 34′. In embodiments the transparent wall 34 may be provided ready made thus removing the need to cut the transparent wall 34 from a transparent wall sheet 34′.

At step 2e the transparent wall 34 is positioned over and aligned with the peripheral portion 92′. The transparent wall 34 is then applied to the peripheral portion 92′ whilst the peripheral portion 92′ is on the release sheet 37′. A second sub-assembly sheet 100′ including the release sheet 37′, peripheral portion 92′ and transparent wall 34 is then rolled up. In embodiments the combination of the release sheet 37′, peripheral portion 92′ and transparent wall 34 may not be rolled up. In embodiments, the transparent wall sheet 34′ may be presented to the peripheral portion 92′ and die cut in the same step so that the transparent wall 34 is cut and applied to the peripheral portion 92′ simultaneously.

Therefore, at the end of step 2e a second sub-assembly sheet 100′ has been manufactured. In embodiments alternative connection or attachment means to adhesives may be used. For example, welding could be used rather than, or in addition to, adhesive connections without departing from the scope of the present invention.

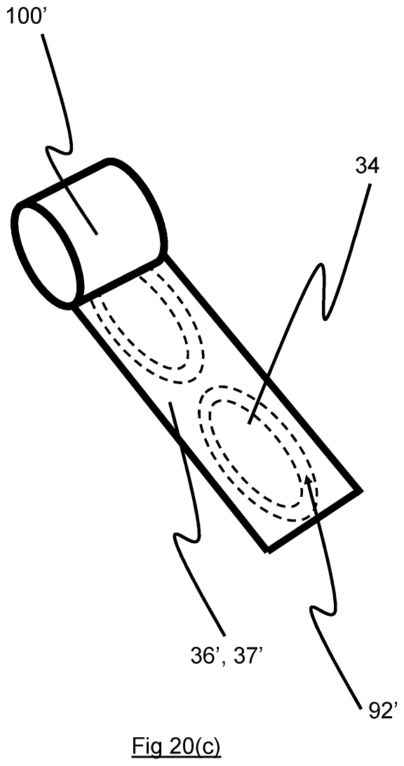

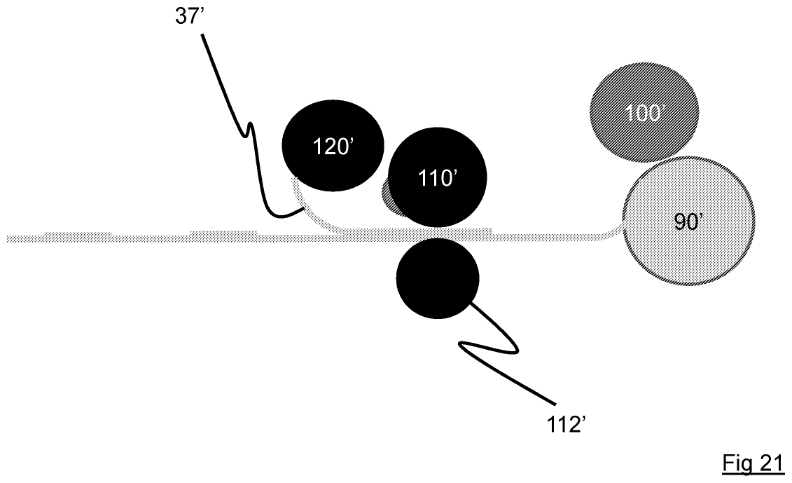

At steps 3a to 3c (see FIG. 21) the first and second sub-assemblies 90′, 100′ are unrolled and fed into the manufacturing process. The transparent wall 34 and peripheral portion 92′ of adhesive are positioned over the opening 28 in the first sub-assembly 90′. An application roller 110′ is then used to apply the transparent wall 34 and peripheral portion 92′ of adhesive around the opening 28 to cover the opening 28. Therefore, this step includes the second connection being formed by applying the adhesive 36 to connect the transparent wall 34 to the first or second wall 12, 14. A further roller 112′ is used to assist the application roller 110′. The release sheet 37′ and excess adhesive are then removed by a waste roller 120′.

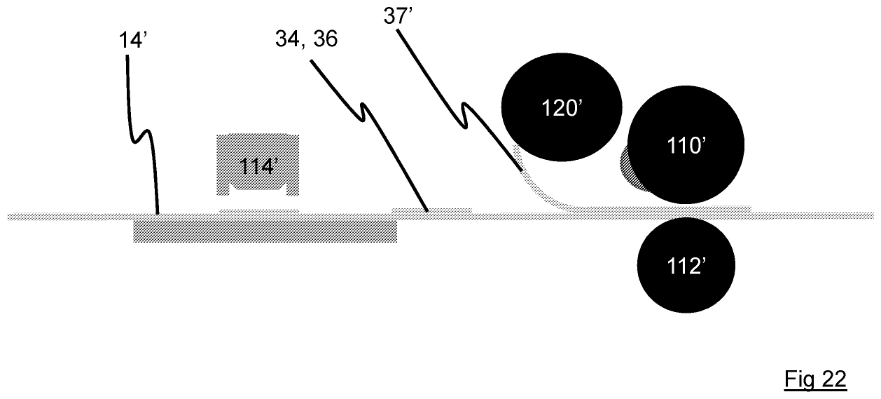

At step 3d (see FIG. 22) the transparent wall 34 and adhesive 36 (as peripheral portion 92′) are pressed onto the second portion 24 of the second wall sheet 14′ by a press 114′. In other words, this process connects the transparent wall 34 to the first or second walls 12, 14 whilst they are part of the first and second wall sheets 12′, 14′. This process also forms a second connection 36. The second connection 36 is substantially as described above in relation to the mask 10.

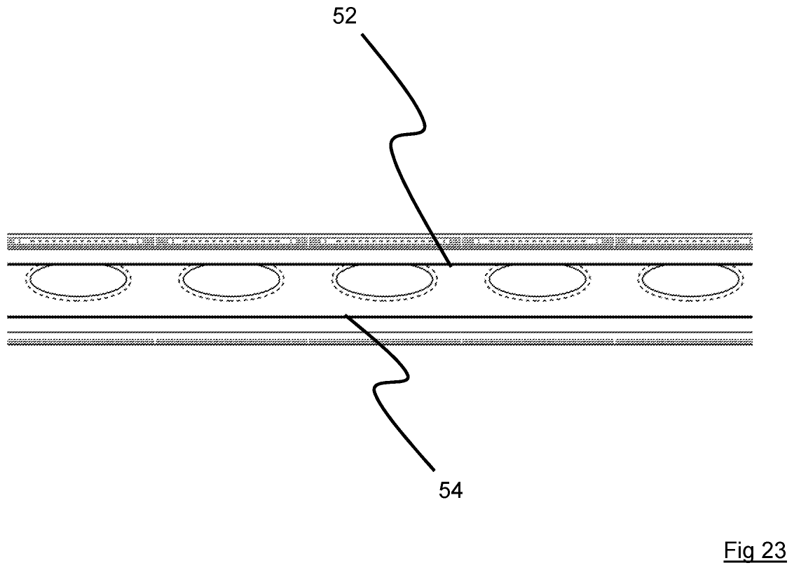

At step 3e (see FIG. 23) the first and second wall sheets 12′, 14′ are folded to form the first and second pleats 52, 54. In embodiments more or fewer pleats may be formed in the mask. In embodiments no pleats may be formed in the mask 10.

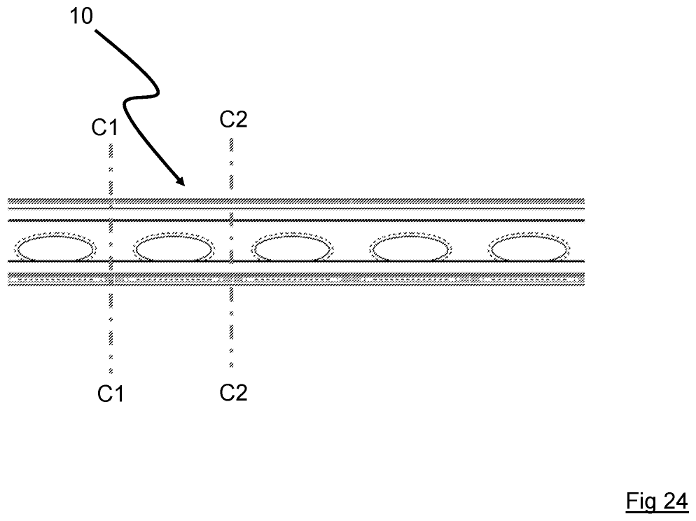

At steps 3f and 3g (see FIG. 24) the first, second and third walls 12, 14, 16 are cut from the first, second and third walls sheets 12′, 14′, 16′ along the lines C1, C2. The lines C1, C2 are generally orthogonal to the top and bottom edges 60, 62. In embodiments where the first, second and third walls 12, 14, 16 are provided preformed step 3f may be omitted.

In the present embodiment the first, second and third walls 12, 14, 16 are cut from the first, second and third wall sheets 12′, 14′, 16′ after the adhesive 36 and transparent wall 34 are applied to the first, second and third wall sheets 12′, 14′, 16′. In embodiments the first, second and third walls 12, 14, 16 are cut from the first, second and third wall sheets 12′, 14′, 16′ before the adhesive 36 and transparent wall 34 are applied to the first, second and third wall sheets 12′, 14′, 16′.

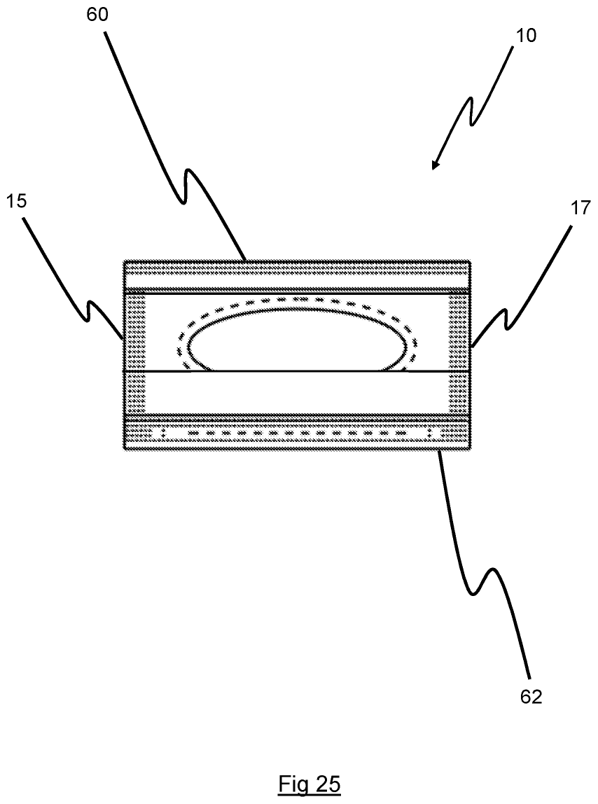

At step 3g (see FIG. 25) the sides 15, 17 of the first, second and third walls 12, 14, 16 are connected to each other such that the first, second and third walls are connected at or near their peripheries. In the present embodiment the sides 15, 17 are connected by welding the first, second and third walls 12, 14, 16 together. In embodiments the sides 15, 17 may be connected by adhesive, stitching or any other appropriate means known in the art.

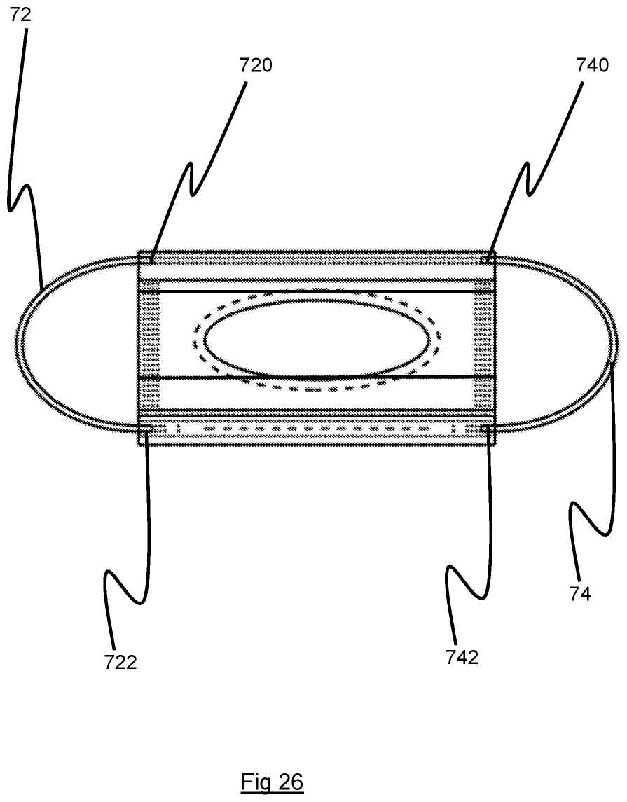

At steps 3h and 3i (see FIG. 26) the first and second attachment formations 72, 74 are fed into the manufacturing process. In the present embodiment the attachment formations 72, 74 have already been cut to size to feed into the manufacturing process. In embodiments one or more attachment formation reels may be provided from which the attachment formations 72, 74 are cut to then be fed into the manufacturing process.

The method includes the step of positioning the attachment formations 72, 74 on the mask 10. The attachment formations 72, 74 are attached as described in relation to the mask 10 above. In particular, in the present embodiment the first and second respective ends of the first and second attachment formations 720, 722, 740, 742 are positioned to respective sides 15, 17 of the mask 10 at the upper edge 60 and bottom edge 62.

At step 3i the attachment formations 72, 74 are connected to the first and/or second walls 12, 14.

In particular, the first and second respective ends of the first and second attachment formations 720, 722, 740, 742 are connected to the first and/or second walls 12, 14. In the present embodiment the attachment formations 72, 74 are welded to the first and/or second walls 12, 14. In particular the first and second respective ends of the first and second attachment formations 720, 722, 740, 742 are welded to the first and/or second walls 12, 14, preferably by an ultrasonic weld. In embodiments the first and second attachment formations 72, 74 may be connected to the first and/or second walls 12, 14 by adhesive, stitching or any other appropriate means known in the art.

At this point the mask 10 is completed and is then packaged ready for shipping.

In the present embodiment the method of manufacture includes making the first and second sub-assemblies 90′, 100′. In embodiments the first and second sub-assemblies 90′, 100′ may be provided preformed. In such embodiments only steps 3a to 3i are necessary as steps 1a to 2e will have been completed in another manufacturing process.

Masks made according to embodiments of the present invention have been found to be particularly effective at preventing transmission of droplets whilst maintaining the visibility through the transparent wall of the mask. This is highly advantageous in comparison to the prior art masks currently available that fail in one or both of these aspects. Advantageous effects are achieved through the present invention utilising two separate connections, namely first connection 32 and the second connection 36 that respectively connect the first, second and third walls 12, 14, 16 together, and the first or second wall 12, 14 to the transparent wall 34. In particular, the use of first and second connections 32, 36 has been found to be advantageous in preventing the transparent wall 34 from peeling away from the mask 10.

The below table sets out how the mask 10 and various components thereof have been found to pass a number of medical and regulatory test standards. This evidences the high performance of the mask 10 for use in medical settings, e.g. surgical settings, in particular. The mask according to the present invention offers a design and performance that performs in a comparable manner to a Type IIR mask for source control and provides an equivalent level of wearer protection against droplets and splashes to a Type IIR medical mask, as specified in BS EN 14683:2019 for medical masks as stipulated in the UK Government's Guidance for Transparent face masks technical specification guidance document sections 5.6 and 6.2 (filtration efficiency and probable mechanism of action) making it safe to the wearer at a comparable level.

| Test | | | Test Body | |
|---|---|---|---|---|
| Code/Specification | | | & | Mask |
| code | Reference | Test Result | Certificates | Component |
| EN 14683:2019 | Biocompatibility | Compliant with | 3M/GLR | First, second and |
| section 5.2.6 | | ISO 10993 PART-1, | Laboratories | third walls 12, 14, |
| | | PART- 5, | | 16 (Donor Mask) |
| | | PART-10 | | Transparent wall |
| | | | | 34 (Diagnostic |
| | | | | Microfluidic |
| | | | | Hydrophilic Film) |
| | | | | Adhesive (Hi- |
| | | | | Tack |
| | | | | Conformable |
| | | | | Double Coated |
| | | | | Tape) |
| EN 14683:2019 | Bacterial | Compliant | 4ward | Mask 10 (whole |
| section 5.2.2 and 5.2.7 | Filtration | >98 (noted | | mask) |
| | Efficiency | deviations) | | |
| BS EN ISO | Wet Bacterial | NA (note point 5 | | N/A |
| 22610:2006 | Penetration | of this email) | | |
| EN 14683:2019 | Breathability | Compliant | 4ward | Mask 10 (whole |
| section 5.2.3 | | <60 (noted | | mask) |
| | | deviations) | | |
| EN 14683:2019 when | Splash | Compliant | 4ward | Mask (whole |
| tested to ISO | Resistance | >29@16kPa | | mask) |
| 22609:2004 | | | | |
| EN 14683:2019 | Microbial | Compliant | 4ward | Mask (whole |
| section 5.2.5 | Cleanliness | <30 | | mask) |
| | (Bioburden) | | | |
| BS EN 166:2002 | Quality of | Pass visual | SATRA | Transparent wall |
| section 7.1.3 | Materials | inspection | | 34 (Microfluidic |
| | | | | Hydrophilic Film) |
| BS EN 166:2002 | Fogging of | Compliant | SATRA | Transparent wall |
| section 7.3.2 | Oculars | >8 | | 34 (Microfluidic |
| | | | | Hydrophilic Film) |

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A mask for inhibiting the transmission of droplets including:
a first wall including a first portion;
a second wall including a second portion;
wherein the first and second wall are connected to each other at or near their peripheries to define a space therebetween;
an opening which extends between the first and second portions and which, in use, overlies a user's mouth;
a first connection which connects the first portion to the second portion to inhibit communication between the opening and the space;
a transparent wall which covers the opening; and
a second connection which connects the transparent wall to the first or second walls.

2. The mask according to claim 1 wherein the first connection and/or the second connection each forms a closed path.

3. The mask according to claim 1 wherein the first and second portions define respective parts of the opening, and the first connection effects joining or fusion of the first and second portions together.

4. The mask according to claim 1 wherein the second connection connects the transparent wall, optionally or preferably a periphery of the transparent wall, to the first or second wall near or around the first or second portion thereof.

5. The mask according to claim 1 wherein the second wall includes a surface which faces towards a user's face during use and the transparent wall is positioned on the surface.

6. The mask according to claim 1 wherein the first connection, in front view, overlaps, overlies or is contiguous and/or congruent with the second connection.

7. The mask according to claim 1 wherein the opening and/or the transparent wall and/or the first connection and/or the second connection form the same shape, optionally or preferable are concentric with each other, optionally or preferably are oval shaped.

8. The mask according to claim 1 wherein the first connection is provided by a weld, preferably an ultrasonic weld.

9. The mask according to claim 1 wherein the second connection is provided by an adhesive, optionally wherein the adhesive is positioned between the second wall and transparent wall or the first wall and transparent wall, preferably between the first/second portion and the transparent wall.

10. The mask according to claim 9 wherein the adhesive includes a backing layer, optionally formed from polyethylene (PE), including first and second sides and first and second adhesive layers attached to the first and second sides respectively;
optionally wherein the first adhesive layer is attached to the second wall and the second adhesive layer is attached to the transparent wall.

11. The mask according to claim 9 wherein the adhesive or the first and/or second adhesive layer includes a synthetic rubber adhesive.

12. The mask according to claim 1 wherein the transparent wall includes, or is formed from, polyethylene terephthalate (PET).

13. The mask according to claim 1 including a third wall connected to the first and second walls about their respective peripheries and positioned in the space between the first and second walls;
optionally wherein the first wall is a sheet material, e.g. a hydrophobic material or a hydrophobic spunbond polypropylene material;
optionally wherein the second wall is a sheet material, e.g. a hydrophilic material or a hydrophilic spundbond polypropylene material;
optionally wherein the third wall is a sheet material e.g. a meltblown polypropylene material.

14. The mask according to claim 1 including a third wall including a third portion that the opening extends through and/or the first connection connects the first, second and third portions.

15. A method of manufacturing a face mask, including the following steps:
a) providing a mask including first and second walls including first and second portions respectively and an opening which extends between the first and second portions and a first connection which connects the first portion to the second portion;
b) providing a transparent wall;
c) positioning the transparent wall so as to cover the opening; and
d) connecting the transparent wall to the first or second walls over the opening by a second connection.

16. A method of manufacturing a face mask, including the steps of:
a) providing first and second walls including first and second portions respectively;
b) cutting an opening through the first and second portions;
c) optionally connecting the first and second portions together by a first connection;
d) providing a transparent wall;
e) positioning the transparent wall so as to cover the opening; and
f) connecting the transparent wall to the first and/or second walls over the opening by a second connection.

17. The method according to claim 15 wherein the step of providing a transparent wall includes the steps of:
providing a transparent wall sheet; and
cutting the transparent wall from the transparent wall sheet.

18. The method according to claim 15 wherein the step of connecting the transparent wall to the first and/or second walls over the opening by a second connection includes the second connection being formed by applying an adhesive to connect the transparent wall to the first or second wall.

19. The method according to claim 18 wherein applying the adhesive to connect the transparent wall to the first and/or second wall includes:
providing an adhesive sheet including the adhesive and a release sheet on which the adhesive is positioned;
cutting the adhesive to match the shape of the transparent wall;
removing an inner portion of the adhesive so that a peripheral portion of the adhesive remains on the release sheet; and
applying the transparent wall to the peripheral portion of the adhesive positioned on the release sheet.

20. The method according to claim 15 wherein the step of connecting the first and second walls includes welding the first and section portions of the walls together around the opening, or the first connection is a weld connection between the first and second portions of the walls around the opening.

21. The method according to claim 15 wherein the step of providing the first and second walls includes: the steps of:
providing first and second wall sheets; and
cutting the first and second walls from the first and second wall sheets.

22. The method according to claim 15 further including one or more or all of the following steps:
providing the first and second wall sheets includes providing the first and second wall sheets as a roll and unrolling the first and second wall sheets prior to cutting the first and second walls from the first and second wall sheets;
providing the transparent wall sheet includes providing the transparent wall sheet as a roll and unrolling the transparent wall sheet prior to cutting the transparent wall from the transparent wall sheet;
providing the second connection by providing an adhesive sheet as a roll and unrolling the adhesive sheet prior to cutting the adhesive to provide the second connection.

23. The method according to claim 15 further including one or more or all of the following:
the opening is generally oval shaped;
the transparent wall is generally oval shaped;
the transparent wall is formed from polyethylene terephthalate (PET);
the adhesive includes one or more or all of the features of any one of claims 9 to 11.
